(19) United States
(12) Patent Application Publication
(10) Pub. No.: US 2005/0111822 A1
(43) Pub. Date: May 26, 2005

(54) Combination theater system and method of controlling operation thereof

(75) Inventor: Byung-hyuk Cho, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/990,439

(22) Filed: Nov. 18, 2004

(30) Foreign Application Priority Data
Nov. 21, 2003 (KR) 2003-83104

(51) Int. Cl. H04N 5/76; H04N 5/781

(52) U.S. Cl. 386/46; 386/125

(57) ABSTRACT

A combination theater system and having a first device and a second device, each performing an independent function, respectively, and further having an operating panel unit for inputting a user operation command, a first controlling unit for controlling the operation of the first device, and detecting and outputting the information about operational status and environment settings of the first device, a second controlling unit for receiving the information outputted from the first controlling unit, and controlling the operation of the first controlling unit and the second device according to the user operation command inputted through the operating panel unit, a selection unit for selecting, according to a control signal from the second controlling unit, one among video/audio signal reproduced from the first and the second devices, and externally-received video/audio signals, and an audio amplifier unit for amplifying the audio signal selected by the selection unit and outputting the amplified signal.

### CROSS-REFERENCE TO RELATED APPLICATION

This application claims the benefit of Korean Patent Application No. 2003-83104 filed Nov. 21, 2003, in the Korean Intellectual Property Office, the disclosure of which is incorporated herein by reference.

### BACKGROUND OF THE INVENTION

1. Field of the Invention

The present invention relates to a combination theater system, and a method of controlling operation thereof. More particularly, the present invention relates to a combination theater system having a plurality of devices integrated therein, which is capable of maintaining an operation of a first device in current use when checking the operation state of a second device and a control method thereof.

2. Description of the Related Art

A system integrating therein more than two different devices is referred to-as a ‘combination system.’ A combination theater system, therefore, refers to such a combination system added with an audio amplification (“AMP”) function.

A DVD (digital versatile disk) player/VCR (videocassette recorder) combination theater system is one example of the combination theater system, which incorporates in a single system a DVD player, a VCR and an AMP for a convenient use of the operator.

FIG. 1 is a block diagram of a DVD player/VCR combination theater system and peripheral devices connected thereto. The DVD player/VCR combination theater system 10 includes a VCR unit 11 which performs a basic operation of a VCR such as reproducing audio and video data from a magnetic tape and recording an externally-received signal in the magnetic tape, a DVD player unit 12 which performs a basic operation of a DVD player, such as reproducing video and audio data from a DVD (digital video disk), and an audio amplification unit 13 which amplifies audio signal and outputs through the speaker and/or a headphone. In addition to these basic functions of the VCR unit 11 and the DVD player unit 12, the DVD player/VCR combination theater system 10 also provides complex function, such as recording video and audio data reproduced from the DVD player unit 12 onto the magnetic tape in the VCR unit 11.

The DVD player/VCR combination theater system 10 is connected with a TV 16 as one of its peripheral devices to output video and audio reproduced from the DVD player unit 12 of the VCR unit 11 thereof, and is also connected with a speaker/headphone 15 as one of its peripheral devices to output audio reproduced by the DVD player 12 through the audio amplification unit 13. Additionally, external devices 17, such as camcorder or digital camera, can be connected to the DVD player/VCR combination theater system 10, and the DVD player/VCR combination theater system 10 receives audio and video inputs from the external devices 17 and performs recording/reproducing operations.

The VCR unit 11, the DVD player unit 12 and the AUDIO amp 13 of the DVD player/VCR combination theater system 10 are provided in a single integrated system, and by using a separate input device, such as a remote controller 14, or manipulating on the operating panel (not shown) provided at the front side of the DVD player/VCR combination theater system 10, the operator can utilize respective functions of the respective units 11, 12, 13 and the mode converting units there between.

s described above, the DVD player/VCR combination theater system 10 is advantageous because the DVD player/VCR combination theater system is able to provide a variety of functions using a single system, that is, saving the burden of having to purchase the units 11, 12, 13, respectively. The problem is that because one decoder is used to decode the units of the DVD player/VCR combination theater system 10 and the external device, only the selected unit of the DVD player/VCR combination theater system 10 can be operated at a time.

For example, when the VCR mode is selected during the DVD player reproducing, to check TV broadcast status of the VCR mode, for example, the DVD player has to stop the reproducing, and the operating mode is switched to a VCR mode so that a selected audio signal can be outputted in the VCR mode. Accordingly, if the operator wants to return to the DVD player, which has been stopped, the operator must start the DVD player reproducing again, taking additional time until the non-operating DVD player starts the reproducing.

### SUMMARY OF THE INVENTION

Additional aspects and/or advantages of the invention will be set forth in part in the description which follows and, in part, will be obvious from the description, or may be learned by practice of the invention.

Accordingly, the present invention solves the above-mentioned and/or problems, and an aspect of the invention is to provide a combination theater system having a plurality of devices integrated therein, which is capable of maintaining operation of a first device in current use when checking the operation status of another device, and a control method thereof.

An aspect of the invention provides be a combination theater system, a first device and a second device, each performing an independent function, respectively. The combination theater system including an operating panel unit for inputting a user operation command, a first controlling unit for controlling the operation of the first device, and detecting and outputting the information about operational status and environment settings of the first device, a second controlling unit for receiving the information outputted from the first controlling unit, and controlling the operation of the first controlling unit and the second device according to the user operation command inputted through the operating panel unit, a selection unit for selecting, according to a control signal from the second controlling unit, one among video/audio signal reproduced from the first and the second devices, and externally-received video/audio signals, and an audio amp unit for amplifying the audio signal selected by the selection unit and outputting the amplified signal.

According to an aspect of the invention, the first device is a DVD player that records and/or reproduces signal to a DVD, and the second device may be a VCR which records and reproduces signal to a magnetic tape.

According to an aspect of the invention, the first controlling unit and the second controlling unit transmit and receive information about the operational status and environment setting of the VCR and the DVD player, respectively.

According to an aspect of the invention, the DVD player includes a DVD player decoder unit which receives reproducing signal from the DVD and outputs DVD video signal and/or DVD audio signal, and/or the DVD decoder unit decodes the audio signal from the selection unit into DVD format, and outputs the decoded signal to the audio amp unit.

According to an aspect of the invention, an A/D converter is provided for converting the audio signal, which is selected at the selection unit, into a digital signal and outputting the digital signal to the DVD decoder unit.

According to an aspect of the invention, when a predetermined mode check command is inputted during the DVD player operation, the second controlling unit controls the first controlling unit to maintain the operation of the DVD player, performs operation corresponding to the inputted command, and controls the selection unit to select one among the video signal and audio signal according to the performed operation and output the selected signal.

According to an aspect of the invention, a control method of a combination theater system which includes a first device and a second device, each performing an independent function, respectively, is provided. The control method includes transmitting an information about operational status and environment setting of the first device to a second controlling unit which controls the second device, performing initialization of the second device according to the received environment setting information of the first device, when a predetermined mode check command is inputted to the second controlling unit through an operating panel, the second controlling unit controlling the first controlling unit, which controls the first device, to maintain the operation of the first device, performing an operation corresponding to the predetermined mode check command, and outputting video signal according to the performed operation, and when an end command is inputted with respect to the predetermined mode check operation through the operating panel, outputting audio and video signal according to the operation of the first device.

According to an aspect of the invention, the first device is a DVD player which records and reproduces a signal to a DVD, and/or the second device is a VCR which records and reproduces signal to a magnetic tape.

According to an aspect of the invention, the first controlling unit and the second controlling unit transmit and receive information about the operational status and environment setting of the VCR and the DVD player, respectively.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional DVD player/VCR combination theater system;

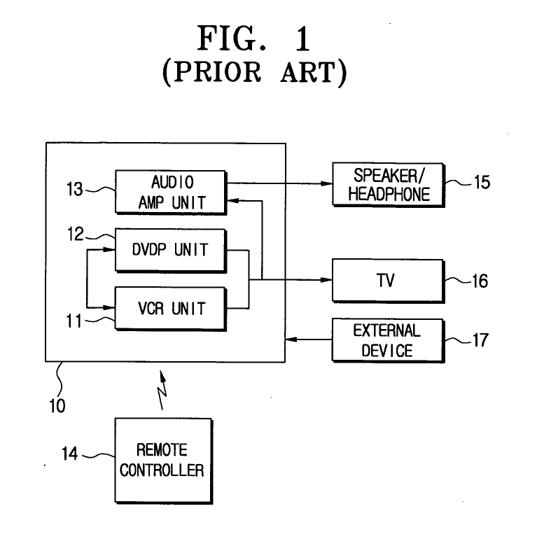

FIG. 2 is a block diagram of a DVD player/VCR combination theater system according to an embodiment of the invention; and

FIG. 3 is a flowchart illustrating the operation of the system as shown in FIG. 2.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

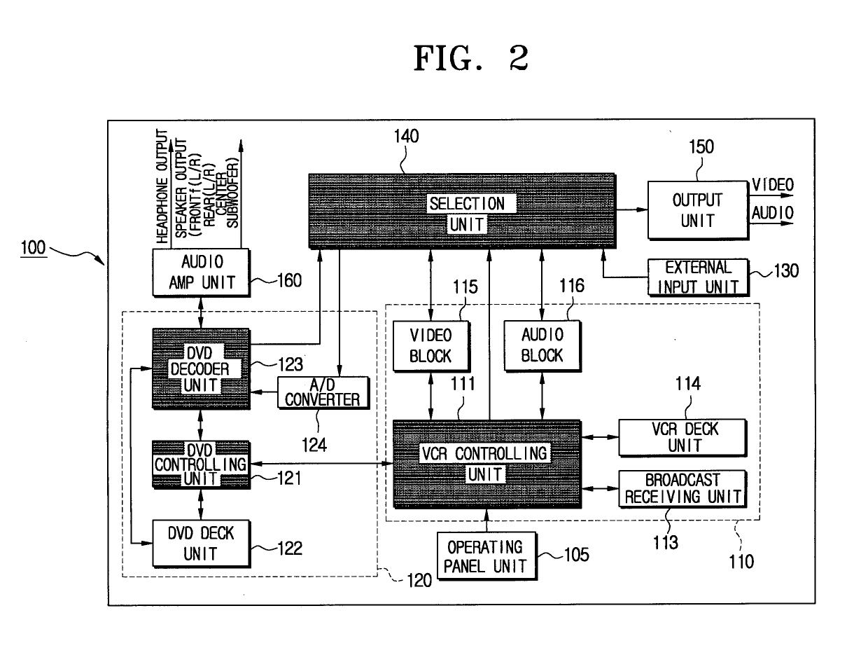

Referring to FIG. 2, a DVD player/VCR combination theater system 100 includes an operating panel 105 for the input of a variety of operation commands from a user, a VCR unit 110 for performing basic functions of the VCR, a DVD player unit 120 for performing functions of the DVD player, an external input unit 130 for the input of video and audio signals from external devices such as camcorder or a digital camera, a selection unit 140 for selecting and outputting one among the input video and audio signals, an output unit 150 for providing the peripheral devices, such as a television, with video and audio signals selected from the selection unit 140, and an audio amp unit 160 for outputting the audio signal selected from the selection unit 140 through the speaker and/or headphone. The DVD player/VCR combination theater system may additionally include a display (not shown) and remote controller sensor (not shown) for indicating operation and controlling status for the notice of the user and setting modes of the DVD player/VCR combination theater system, respectively.

The VCR unit 110 includes a broadcast receiving unit 113 for receiving a television broadcast signal, a VCR deck 114 for recording and/.or reproducing a signal with respect to a magnetic tape, a video block 115 and an audio block 116 for receiving and transmitting video and audio recorded or reproduced from the VCR deck 140, and a VCR controlling unit 111 for controlling the overall operation of the VCR deck 114, the video block 115 and the audio block 116.

The DVD player unit 120 includes a DVD controlling unit 121, a DVD deck 122, a DVD decoder unit 123 and an A/D converter 124. The DVD deck 122 reads in data from the DVD to perform reproducing with respect to the DVD, and the DVD decoder unit 123 acquires data from the DVD deck 122 via the DVD controlling unit 121 and outputs DVD video data and/or DVD audio data. Meanwhile, the audio signal selected by the selection unit 140 is converted from analog to digital by an A/D converter 124, decoded in the DVD decoder unit 123 and outputted as a DVD audio signal. The DVD controlling unit 121 controls the operations of the DVD deck 122 and the DVD decoder unit 123. While described in terms of a player that reproduces the DVD, it is understood that the player can further record data with respect to the DVD.

The DVD controlling unit 121 transmits to the VCR controlling unit 111 information regarding the operation status and environment settings of the DVD player. The VCR controlling unit 111 transmits to the DVD controlling unit 121 information regarding the VCR operation status and environment settings of the VCR.

According to an aspect of the invention, the VCR controlling unit 111 and the DVD controlling unit 121 are separately provided. The VCR controlling unit 111 is used as the main controlling unit of the DVD player/VCR combination theater system 100 such that the DVD controlling unit 121 is controlled in accordance with the operation commands from the main controlling unit. However, this is only one aspect of the invention, and the invention is not limited to this particular example. Therefore, the DVD controlling unit 121 may be used as the main controlling unit of the DVD player/VCR combination theater system, or a main controlling unit integrating therein the function of the VCR controlling unit 111 and the DVD controlling unit 121, may be used.

According to an aspect of the invention, as shown in FIG. 2, signals from the DVD decoder unit 123, the video block 115, the audio block 116, or the external input unit 130, are inputted to the selection unit 140. The selection unit 140 is controlled by the VCR controlling unit 111 and the DVD controlling unit 121, and operates to select among inputted signals. The signals from the selection unit 140 are inputted to the output unit 150. Also, the signals from the selection unit 140 are sent out to the DVD decoder unit 123 for amplification and output.

The output unit 150 receives signals from the selection unit 140, and outputs signals for at least DVD video, DVD audio, VCR video and/or VCR audio. The output unit 150 is connected with peripheral devices, such as a television or audio device, and accordingly, video and audio signals are outputted through the connected peripheral devices.

The external input unit 130 is connected with the selection unit 140, and transmits the externally-received signal to the selection unit 140. Signal output terminals of the external devices, such as camcorder or a digital camera, are connected to the selection unit 140. Accordingly, signals recorded in the external devices are able to be transmitted to the DVD player/VCR combination theater system 100 via the selection unit 140, and furthermore, signals from the external devices are able to be recorded in the magnetic tape by using the VCR unit 110 or the signals from the external devices are able to be reproduced through the television or monitor.

For example, when power is supplied to the DVD player/VCR combination theater system 100 and DVD player operation command is inputted to the VCR controlling unit 111, the VCR controlling unit 111 transmits a corresponding control signal to the DVD controlling unit 121 under a predetermined protocol. According to the control signal, the DVD controlling unit 121 controls the operation of DVD deck 122 and the DVD decoder unit 123. DVD video and DVD audio signals from the DVD player unit 120 are inputted to the selection unit 140, and according to the control signal from the VCR controlling unit 111, the selection unit 140 sends out DVD video and DVD audio signals to the output unit 150. Further, the DVD audio signal may be inputted from the DVD decoder unit 123 to the audio amp unit 160 and outputted through the speaker and/or headphone.

Meanwhile, when audio signals, such as the VCR reproducing signal, TV broadcast input signal, and external device input signal, are inputted to the DVD decoder unit 123 through the selection unit 140, the VCR controlling unit 111 controls the selection unit 140 and the DVD controlling unit 121 so that the audio signal, which is decoded in the DVD decoder unit 123, is able to be amplified in the audio amp unit 160 and outputted through the speaker and/or headphone.

According to an aspect of the invention, the DVD decoder 123 is able to process and output video and/or audio signals of the DVD player unit 120, or process audio signals from the VCR unit 110 and output the same to the audio amp unit 160, but the DVD decoder is unable to perform both of the above process at the same time. Accordingly, in order to process audio signal from the VCR unit 110, signal processing by the DVD player should be stopped.

When the audio signal of the VCR unit 110, which is inputted through the selection unit 140, is inputted to the DVD decoder 123, the VCR controlling unit 111 controls the DVD controlling unit 121 to continue DVD player reproducing operation, and also controls the selection unit 140 to construct “VCR mode confirm” so that outputs, such as VCR-reproduced output, TV tuner output and external device output, are able to be outputted through the output unit 150 without stopping the reproducing or recording of the DVD player. That is, the inputting status of the VCR unit 110 can be confirmed without stopping the DVD player reproducing.

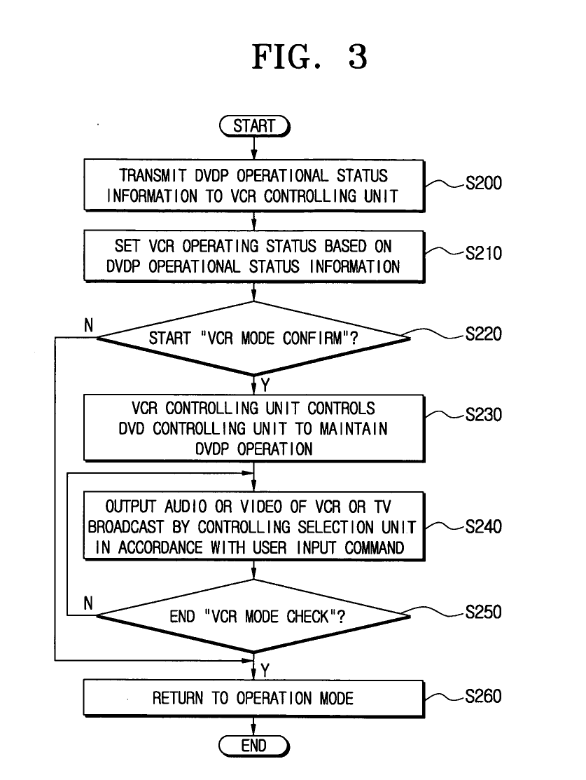

FIG. 3 is a flowchart illustrating the operation of the DVD player/VCR combination theater system 110 according to an aspect of the invention. The following is an example method of performing a VCR mode confirm while the DVD player is operating.

When power is supplied to the DVD player/VCR combination theater system 110 and an operation command is inputted through the operating panel unit 105, the DVD player unit 120 operates. The DVD controlling unit 121 transmits information about DVD player operation and environment settings to the VCR controlling unit 111 according to a predetermined protocol (operation S200). The VCR controlling unit 111 initializes the VCR unit 110 (operation S210) for a “VCR mode confirm” function, by using the information received from the DVD controlling unit 121. When the setting is completed, to the VCR controlling unit 111 detects whether an execution command for the “VCR mode confirm” function is inputted (operation S220). The “VCR mode confirm” is any function that confirms that the VCR unit 110 is operating.

For example, when there is a command directing to confirm the reception of a particular broadcast signal, and the VCR controlling unit 111 detects the execution command for “VCR mode confirm”, the VCR controlling unit 111 performs the “VCR mode confirm” function. The VCR controlling unit 111 controls the DVD controlling unit 121 to maintain DVD player reproducing (operation S230), and controls the broadcast receiving unit 113 to tune in to a corresponding channel and received broadcast signals. Further, the VCR controlling unit 111 controls the selection unit 140 to operate as requested by the user (operation S240). The selection unit 140 transmits the video and/or audio signals of the received broadcast signals of the broadcast receiving unit 113 to the output unit 150.

The VCR controlling unit 111 detects whether the “VCR mode confirm” function is completed (operation S250). When the “VCR mode confirm” is completed, the “VCR mode confirm” function is ended. The controlling unit stops the operation of the broadcast receiving unit 113, and controls the selection unit 140 to select among the DVD video and/or DVD audio signal (operation S260).

By controlling the system as described above, the device in current use does not need to be stopped in order to check the operational status of another device of the DVD player/VCR combination theater system 110.

According to the present invention, a DVD player/VCR combination theater system includes a single shared decoder. Therefore, when the DVD player unit is currently reproducing data and it is required to check the VCR mode, in order to, for example, check whether a viewer's awaiting television program has begun, the DVD player reproducing or recording needs not be stopped. Therefore, the operation is improved because the viewer is able to check the VCR mode and then return to the DVD player reproducing and enjoys the contents from whence he/she has come.

While described in terms of a DVD player and VCR combination, it is understood that other combinations can be made using other types of media, such as Bluray, advanced optical discs, magneto-optical media, semiconductor media, and other media types.

Further, it is understood that the method of operating the plurality of recording and/or reproducing devices may be performed using a software program to be read by a computer.

Although a few embodiments of the present invention have been shown and described, it would be appreciated by those skilled in the art that changes may be made in these embodiments without departing from the principles and spirit of the invention, the scope of which is defined in the claims and their equivalents.

1. A combination theater system comprising:
a first device and a second device, each of the first device and the second device performing an independent function, respectively;
an operating panel unit for inputting a user operation command;
a first controlling unit for controlling the operation of the first device, and detecting and outputting information relating to an operational status and environment setting of the first device;
a second controlling unit for receiving the information outputted from the first controlling unit, and controlling the operation of the first controlling unit and the second device according to the user operation command inputted through the operating panel unit;
a selection unit for selecting, according to a control signal from the second controlling unit, one of an audio and/or a video signal reproduced from one of the first device, the second device, or an external device; and
an audio amplifier unit for amplifying the audio signal selected by the selection unit and outputting the amplified signal.

2. The combination theater system of claim 1, wherein the first device is a DVD player which records and reproduces a signal to a digital versatile disc (DVD), and the second device is a video cassette recorder (VCR) which records and reproduces a signal to a magnetic tape.

3. The combination theater system as claimed in claim 2, wherein the first controlling unit and the second controlling unit transmit and receive information relating to the operational status and environment setting of the VCR and the DVD player, respectively.

4. The combination theater system as claimed in claim 2, wherein the DVD player comprises:
a DVD player decoder unit which receives a reproducing signal from the DVD and outputs a DVD video signal and a DVD audio signal.

5. The combination theater system as claimed in claim 4, wherein the DVD player decoder unit decodes the audio signal from the selection unit into a DVD format, and outputs the decoded signal to the audio amplifier unit.

6. The combination theater system as claimed in claim 5, further comprising:
an A/D converter for converting the audio signal, which is selected at the selection unit, into a digital signal and outputting the digital signal to the DVD decoder unit.

7. The combination theater system as claimed in claim 5, wherein, when a predetermined mode check command is inputted during the DVD player operation, the second controlling unit controls the first controlling unit to maintain the operation of the DVD player, performs an operation corresponding to the inputted command, controls the selection unit to select the video signal or the audio signal according to the performed operation, and outputs the selected video or audio signal.

8. A control method of a combination theater system having a first device and a second device, each of the first device and the second device performing an independent function, respectively, the control method comprises:
transmitting information relating to an operational status and environment setting of the first device to a second controlling unit which controls the second device;
initializing the second device according to the received environment setting information of the first device;
controlling the first controlling unit via the second controlling unit to maintain the operation of the first device when a predetermined mode check command is inputted to the second controlling unit via an operating panel;
performing an operation corresponding to the predetermined mode check command, and outputting an audio and/or video signal according to the performed operation; and
when an end command is inputted with respect to the predetermined mode check operation through the operating panel, outputting the audio and/or video signal according to the operation of the first device.

9. The control method as claimed in claim 8, wherein the first device is a DVD player which records and reproduces a signal to a DVD, and the second device is a VCR which records and reproduces a signal to a magnetic tape.

10. The control method as claimed in claim 9, wherein the first controlling unit and the second controlling unit transmit and receive information relating to the operational status and the environment setting of the VCR and the DVD player, respectively.

11. A system having a plurality of integrated recording and/or reproducing devices comprising:
a main controlling unit of a recording and/or reproducing device to control operations of the plurality of integrated controlling recording and/or reproducing devices; and
a selection unit to receive a control signal from the controlling unit, select an audio signal or a video signal reproduced from one of the plurality of integrated recording and/or reproducing devices corresponding to the received control signal, and output the selected signal,
wherein the plurality of integrated recording and/or reproducing devices operate simultaneously and control signals are transmitted between each of the plurality of integrated recording and/or reproducing devices under a predetermined protocol.

12. The system having the plurality of integrated recording and/or reproducing devices as claimed in claim 11, wherein the plurality of integrated recording and/or reproducing devices comprises:
a first device and a second device, each of the first device and the second device perform an independent function, respectively.

13. The system having the plurality of integrated recording and/or reproducing devices as claimed in claim 12, wherein the first device is a VCR or a DVD player, and the second device is the other of the VCR or the DVD player.

14. The system having the plurality of integrated recording and/or reproducing devices as claimed in claim 12, wherein the main controlling unit is a first device controlling unit of the first device or a second device controlling unit of the second device, such that the main controlling unit receives operational information from the plurality of integrated recording and/or reproducing devices and controls the operation of the plurality of integrated recording and/o reproducing devices according to a user operation command.

15. The system having the plurality of integrated recording and/or reproducing devices as claimed in claim 14, further comprising:
an operating panel unit for inputting the user operation command.

16. The system having the plurality of integrated recording and/or reproducing devices as claimed in claim 14, wherein the first controlling unit for controlling the operation of the first device detects and outputs the operational information relating to the first device.

17. The system having the plurality of integrated recording and/or reproducing devices as claimed in claim 11, further comprising:
an audio amplifier unit for amplifying the audio signal selected by the selection unit and outputting the amplified signal to a speaker.

18. The system having the plurality of integrated recording and/or reproducing devices as claimed in claim 17, further comprising:
an A/D converter to convert the audio signal selected by the selection unit into a digital signal;
a decoder of one of the plurality of integrated recording and/or reproducing devices to receive the digital signal, decode the digital signal, and output the decoded signal to the audio amplifier unit,
wherein the decoder is controlled by the controlling unit of the respective integrated recording and/or reproducing device.

19. The system having the plurality of integrated recording and/or reproducing devices as claimed in claim 17, wherein the plurality of integrated recording and/or reproducing devices further comprises:
can external input unit to input audio and/or video data to the selection unit.

20. A method of controlling a plurality of integrated recording and/or reproducing devices comprising:
controlling operations of the plurality of integrated recording and/or reproducing devices via a main controlling unit of one of the plurality of integrated recording and/or reproducing devices;
transmitting a control signal from the main controlling unit to a selection unit;
selecting an audio signal and/or a video signal reproduced from one of the plurality of integrated recording and/or reproducing devices corresponding to the received control signal; and
outputting the selected audio signal and/or video signal,
wherein the plurality of integrated recording and/or reproducing devices operate simultaneously and control signals are transmitted between each of the plurality of integrated recording and/or reproducing devices under a predetermined protocol.

21. The method of controlling the plurality of integrated recording and/or reproducing devices as claimed in claim 20, wherein the plurality of integrated recording and/or reproducing devices comprises:
a first device and a second device, each of the first device and the second device perform an independent function, respectively.

22. The method of controlling the plurality of integrated recording and/or reproducing devices as claimed in claim 21, wherein the first device is a VCR or a DVD player, and the second device is the other of the VCR or the DVD player.

23. The method of controlling the plurality of integrated recording and/or reproducing devices as claimed in claim 22, further comprising:
transmitting operational information from the DVD player to the main controlling unit of the VCR when power is supplied and an operational command is inputted according to the predetermined protocol, and
initializing the VCR to confirm and perform the operational command; and
controlling the DVD player to simultaneously reproduce audio and/or video while simultaneously controlling a selection unit to operate according to the operational command,
wherein the controlling is performed via the main controlling unit of the VCR.

24. The method of controlling the plurality of integrated recording and/or reproducing devices as claimed in claim 23, wherein the DVD player operates simultaneously while an operational status of another of the plurality of integrated recording and/or reproducing devices is determined.

25. The method of controlling the plurality of integrated recording and/or reproducing devices as claimed in claim 23, wherein the selection unit selects the audio signal and/or the video signal while the plurality of integrating recording and/or reproducing devices are operating.
